(19) United States
(12) Patent Application Publication
(10) Pub. No.: US 2023/0001709 A1
(43) Pub. Date: Jan. 5, 2023

(54) METHOD FOR MANUFACTURING BEVERAGE USE CAN, BEVERAGE USE CAN, AND PRINTING DEVICE

(71) Applicant: ALTEMIRA Co., Ltd., Tokyo (JP)

(72) Inventors: Shinichi OJIMA, Shinagawa-ku,Tokyo (JP); Kazuhisa MASUDA, Shinagawa-ku,Tokyo (JP)

(73) Assignee: ALTEMIRA Co., Ltd., Tokyo (JP)

(21) Appl. No.: 17/783,642

(22) PCT Filed: Dec. 7, 2020
(86) PCT No.: PCT/JP2020/045402

§ 371 Date: Jun. 8, 2022

(30) Foreign Application Priority Data
Jan. 29, 2020 (JP) 2020-012872

(51) Int. Cl. B41J 3/407; B65D 1/16; B65D 25/34

(52) U.S. Cl. CPC B41J 3/40733; B65D 1/165; B65D 25/34; B65D 2203/12

(57) ABSTRACT

A method for manufacturing a beverage use can, which is provided with a cylindrical part with one end portion and the other end portion, a bottom part positioned at the one end portion of the cylindrical part, the bottom part having an outer circumferential surface with an outer diameter gradually increasing with a move toward the other end portion of the cylindrical part, includes a protection layer forming process applying ink to the outer circumferential surface of the bottom part to form a protection layer on the outer circumferential surface.

### TECHNICAL FIELD

The present invention relates to a method for manufacturing a beverage use can, a beverage use can, and a printing device.

### BACKGROUND ART

Patent Document 1 discloses a method for manufacturing a can body including: a basic forming step in which a metallic material is formed into a cylindrical base can body; and a printing step in which print processing is performed on an outer peripheral surface of the base can body formed in the basic forming step.

### CITATION LIST

### Patent Literature

Patent Document 1: Japanese Patent Application Laid-Open Publication No. 2008-183613

### SUMMARY OF INVENTION

### Technical Problem

In beverage use cans, printing is usually performed on the outer circumferential surface of the cylindrical part, and a protection layer is formed on the image formed by the printing. This forms the image and the protection layer on the outer circumferential surface of the cylindrical part.

In contrast thereto, the image and the protection layer are not formed on the bottom part, and thereby the bottom part is left exposed. In addition, a chemical conversion treatment is often performed on the beverage use can; however, the liquid used for the chemical conversion treatment is difficult to stay on the outer circumferential surface of the bottom part, and the effect of the chemical conversion treatment on the outer circumferential surface of the bottom part is likely to be small.

An object of the present invention is to protect an outer circumferential surface of a bottom part of a beverage use can.

### Solution to Problem

A method for forming a beverage use can, to which the present invention is applied, in which the beverage use can is provided with a cylindrical part with one end portion and the other end portion, and a bottom part positioned at the one end portion of the cylindrical part, the bottom part having an outer circumferential surface with an outer diameter gradually increasing with a move toward the other end portion of the cylindrical part, includes a protection layer forming process applying ink to the outer circumferential surface of the bottom part to form a protection layer on the outer circumferential surface.

Here, when an image is formed on an outer circumferential surface of the cylindrical part by using ink, the protection layer may be formed by applying ink on the outer circumferential surface of the bottom part.

In addition, the protection layer may be formed by applying ink on the outer circumferential surface of the bottom part by using an image forming unit forming an image on an outer circumferential surface of the cylindrical part.

Moreover, the method may further include an image forming process forming an image on an outer circumferential surface of the cylindrical part, wherein formation of an image in the image forming process and application of ink to the outer circumferential surface in the protection layer forming process may be performed by a common inkjet head.

Moreover, ink may be ejected from an inkjet head to an outer circumferential surface of the cylindrical part to form an image on the outer circumferential surface, and ink may be ejected from an inkjet head to the outer circumferential surface of the bottom part to form the protection layer, and an ink ejection condition when ink is ejected from the inkjet head to the outer circumferential surface of the cylindrical part may be different from an ejection condition when ink is ejected from the inkjet head to the outer circumferential surface of the bottom part.

In addition, an amount of ink per a single droplet when ink is ejected from the inkjet head to the outer circumferential surface of the cylindrical part may be different from an amount of ink per a single droplet when ink is ejected from the inkjet head to the outer circumferential surface of the bottom part.

Moreover, an image may be formed on the outer circumferential surface of the bottom part by applying the ink to the outer circumferential surface, and a bottom part image, which is an image formed on the outer circumferential surface of the bottom part, may be formed to cause a design pattern included in the bottom part image to continue to a design pattern included in a cylindrical part image, which is an image formed on an outer circumferential surface of the cylindrical part.

Moreover, an image composed of inks of plural colors may be formed on an outer circumferential surface of the cylindrical part, and, in the protection layer forming process, ink of part of the plural colors may be applied to the outer circumferential surface of the bottom part to form the protection layer.

In addition, the method may further include an image forming process forming an image on an outer circumferential surface of the cylindrical part, wherein, in the image forming process, a colored underlayer may be formed on the outer circumferential surface of the cylindrical part, and then ink may be applied on the colored underlayer to form an image on the underlayer, the beverage use can may be made of metal, and, in the protection layer forming process, ink may be applied onto a metal base positioned on the outer circumferential surface of the bottom part to form the protection layer on the outer circumferential surface of the bottom part.

Moreover, the method may further include an image forming process applying ink to an outer circumferential surface of the cylindrical part by using one ink application method and forming an image on the outer circumferential surface, and, in the protection layer forming process, ink may be applied to the outer circumferential surface of the bottom part by using another ink application method, which is different from the one ink application method, to form the protection layer.

In addition, in the image forming process, ink may be applied to the outer circumferential surface of the cylindrical part by using a plate printing method to form an image on the outer circumferential surface, and, in the protection layer forming process, ink may be applied to the outer circumferential surface of the bottom part by using an inkjet head method to form the protection layer.

Moreover, in the case where the present invention is grasped as a beverage use can, a beverage use can to which the present invention is applied includes: a cylindrical part with one end portion and the other end portion; and a bottom part positioned at the one end portion of the cylindrical part, wherein the bottom part has an outer circumferential surface with an outer diameter gradually increasing with a move toward the other end portion of the cylindrical part, and the outer circumferential surface of the bottom part is provided with a protection layer formed by adhesion of ink and curing of the ink.

Here, a design pattern may be formed in the protection layer.

In addition, a continuous design pattern may be formed from an outer circumferential surface of the cylindrical part to the outer circumferential surface of the bottom part.

Moreover, a character string along a circumferential direction of the beverage use can may be formed in the protection layer.

From another standpoint, a beverage use can to which the present invention is applied includes: a cylindrical part with one end portion and the other end portion; and a bottom part positioned at the one end portion of the cylindrical part, wherein the bottom part has an outer circumferential surface with an outer diameter gradually increasing with a move toward the other end portion of the cylindrical part, and the outer circumferential surface of the bottom part is provided with a protection layer containing a coloring material.

Moreover, in the case where the present invention is grasped as a printing device, a printing device performing printing onto a beverage use can, to which the present invention is applied, in which the beverage use can is provided with a cylindrical part with one end portion and the other end portion, and a bottom part positioned at the one end portion of the cylindrical part, the bottom part having an outer circumferential surface with an outer diameter gradually increasing with a move toward the other end portion of the cylindrical part, includes a protection layer forming unit applying ink to the outer circumferential surface of the bottom part to form a protection layer on the outer circumferential surface.

### Advantageous Effects of Invention

According to the present invention, it is possible to protect an outer circumferential surface of a bottom part of a beverage use can.

### BRIEF DESCRIPTION OF DRAWINGS

FIGS. 1A and 1B are diagrams illustrating a beverage use can;

FIGS. 2A and 2B are diagrams showing the outer appearance and the cross-sectional structure of the beverage use can after the formation of an image on the cylindrical part and the formation of a protection layer on the bottom part are performed;

FIG. 3 is a diagram illustrating a chemical conversion treatment;

FIG. 4 is a diagram showing a printing device performing printing onto the beverage use can;

FIG. 5 is a diagram showing a paint application device;

FIG. 6 is a diagram in the case where a printing part and a first protection layer forming part are viewed from the direction indicated by the arrow IV in FIG. 4;

FIGS. 7A to 7E are diagrams showing the changes in the cross-sectional structure of the beverage use can;

FIG. 8 is a diagram showing another configuration example of the printing part, in which the printing part is viewed from above;

FIG. 9 is a diagram showing another configuration example of the beverage use can;

FIG. 10 is a diagram showing still another configuration example of the printing part, in which the printing part is viewed from above;

FIG. 11 is a diagram showing another configuration example of the printing device; and

FIG. 12 is a diagram showing another disposition example of inkjet heads.

### DESCRIPTION OF EMBODIMENT

Hereinafter, an exemplary embodiment according to the present invention will be described with reference to attached drawings.

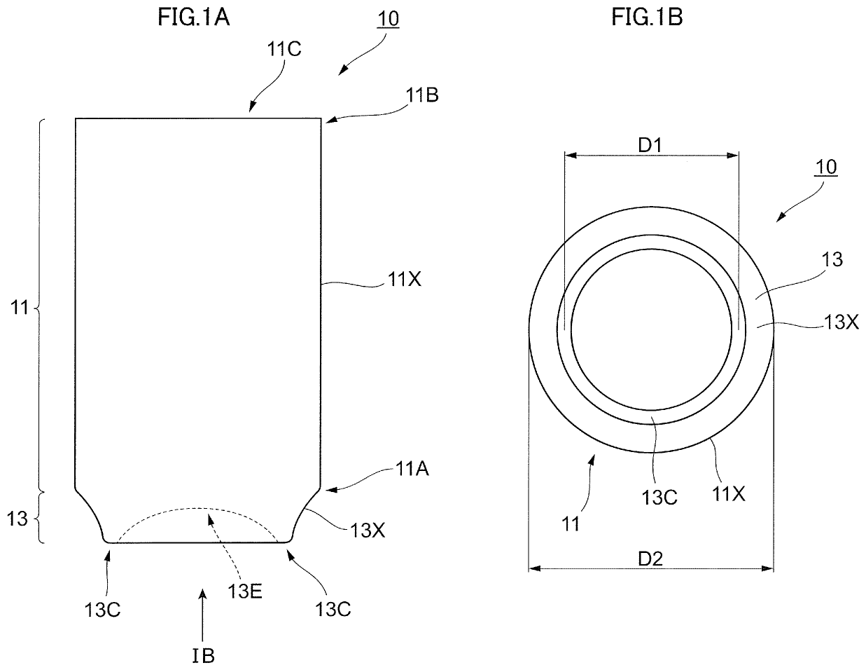

FIGS. 1A and 1B are diagrams illustrating a beverage use can 10 related to the exemplary embodiment. FIG. 1A is an elevational view of the beverage use can 10, and FIG. 1B is a diagram in the case where the beverage use can 10 is viewed from the direction of the arrow IB in FIG. 1A.

FIGS. 1A and 1B show the state before a cylindrical part image and a protection layer, which will be described later, are formed. In other words, FIGS. 1A and 1B show the state of a base can before printing and so forth are performed.

As shown in FIGS. 1A and 1B, the beverage use can 10 is provided with a cylindrical part 11 that is formed cylindrically. As shown in FIG. 1A, the cylindrical part 11 includes one end portion 11A and the other end portion 11B.

The one end portion 11A of the cylindrical part 11 is provided with a bottom part 13; in the exemplary embodiment, the one end portion 11A of the cylindrical part 11 is closed by the bottom part 13.

In the exemplary embodiment, the cylindrical part 11 and the bottom part 13 are integrated. To put is another way, the beverage use can 10 in the exemplary embodiment is not an assembly of plural components, but is formed by deforming one base material.

As shown in FIG. 1A, in the other end portion 11B of the cylindrical part 11, a circular opening 11C is formed.

In the exemplary embodiment, the beverage use can 10 is filled with a beverage, which is the contents, through the opening 11C positioned at the other end portion 11B of the cylindrical part 11.

Thereafter, the opening 11C is closed by a not-shown can lid. This completes a beverage can filled with the beverage.

Examples of the beverage to be charged includes alcoholic beverages, such as beers, and non-alcoholic beverages, such as soft drinks.

Here, in the exemplary embodiment, the beverage use can 10 refers to an empty can before being filled with a beverage, and the beverage can refers to a can after being filled with a beverage, which is the contents.

The beverage use can 10 in the exemplary embodiment is made of metal, and is formed by a metal material. Specifically, the beverage use can 10 is formed by aluminum or an aluminum alloy, for example.

In addition, the beverage use can 10 is formed by, for example, performing drawing and ironing (DI) molding or stretching and drawing molding on a plate material in a flat plate shape.

Here, as shown in FIG. 1B, in the case where the beverage use can 10 is viewed from the one end portion 11A side of the cylindrical part 11 (refer to FIG. 1A) (in the case where the beverage use can 10 is viewed from the direction indicated by the arrow IB in FIG. 1A), the bottom part 13 refers to a portion facing the viewer of the beverage use can 10.

In other words, in the case where the beverage use can 10 is viewed from the one end portion 11A side of the cylindrical part 11, the bottom part 13 refers to the portion that is visible from the one end portion 11A side.

As shown in FIG. 1A, the bottom part 13 includes an outer circumferential surface 13X. The outer circumferential surface 13X has an outer diameter that increases with the move toward the other end portion 11B of the cylindrical part 11.

In addition, in the exemplary embodiment, as shown in FIG. 1B, the bottom part 13 is provided with an annular-shaped protrusion part 13C.

The protrusion part 13C protrudes in a direction away from the other end portion 11B side (refer to FIG. 1A) of the cylindrical part 11. Moreover, in the exemplary embodiment, as shown in FIG. 1B, the diameter D1 of the protrusion part 13C is smaller than the outer diameter D2 of the cylindrical part 11.

In the exemplary embodiment, between (the top portion of) the protrusion part 13C and the cylindrical part 11, the above-described outer circumferential surface 13X is located to connect the protrusion part 13C and the outer circumferential surface 11X of the cylindrical part 11.

Further, as shown in FIG. 1A, of the bottom part 13, inside the annular-shaped protrusion part 13C, a concave part 13E that concaves toward the other end portion 11B of the cylindrical part 11 is provided.

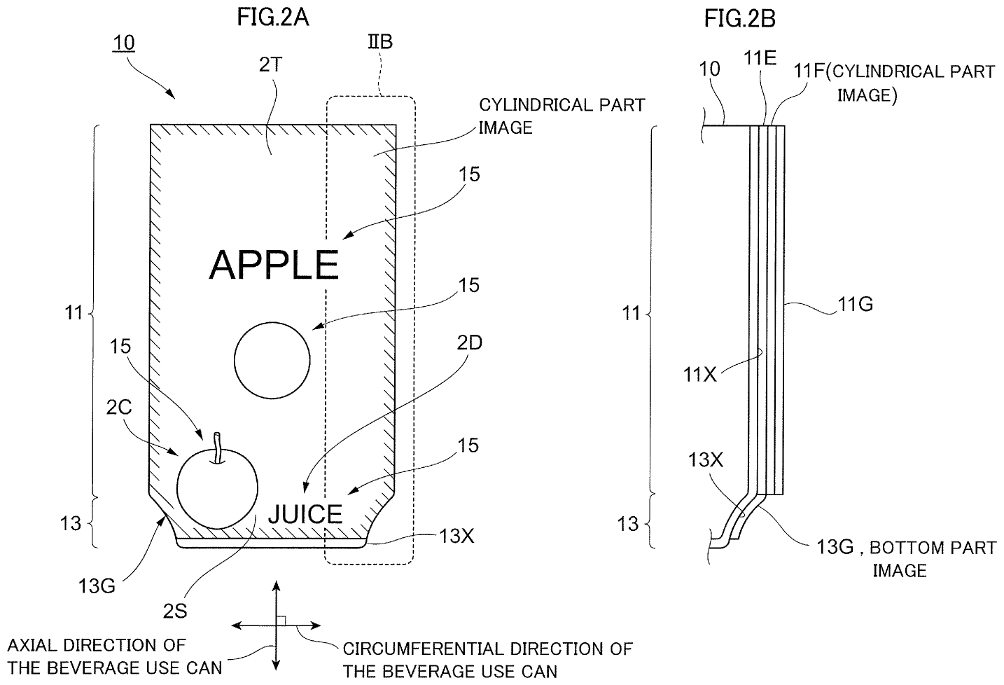

FIGS. 2A and 2B are diagrams showing the outer appearance and the cross-sectional structure of the beverage use can 10 after the formation of an image on the cylindrical part 11 and the formation of a protection layer on the bottom part 13 are performed.

Specifically, FIG. 2A shows the outer appearance of the beverage use can 10. In addition, FIG. 2B shows the cross-sectional structure of the portion indicated by the reference sign IIB in FIG. 2A.

In the exemplary embodiment, as shown in FIG. 2B, an image layer 11F is provided on the outer circumferential surface 11X of the cylindrical part 11. Further, on the image layer 11F, a transparent protection layer 11G that protects the image layer 11F is provided.

Still further, in the exemplary embodiment, on the outer circumferential surface 13X of the bottom part 13, a protection layer 13G, which is formed by ink adhesion and curing of the ink, is provided.

In other words, the outer circumferential surface 13X of the bottom part 13 is provided with the protection layer 13G containing coloring materials. Here, examples of the coloring materials include dyes and pigments.

Note that the coloring material is not essential; transparent ink may be applied to the outer circumferential surface 13X of the bottom part 13, to thereby form the transparent protection layer 13G on the outer circumferential surface 13X of the bottom part 13. Details of formation of the protection layer 13G will be described later.

In the exemplary embodiment, the protection layer 13G is colored, and, as shown in FIG. 2A, an image is formed on the outer circumferential surface 13X of the bottom part 13 by the protection layer 13G.

In the exemplary embodiment, the image is formed not only on the outer circumferential surface 11X of the cylindrical part 11, but also on the outer circumferential surface 13X of the bottom part 13; accordingly, the image is formed on both the outer circumferential surface 11X of the cylindrical part 11 and the outer circumferential surface 13X of the bottom part 13.

Furthermore, in the exemplary embodiment, as shown in FIG. 2A, each of the image formed on the outer circumferential surface 11X of the cylindrical part 11 and the image formed on the outer circumferential surface 13X of the bottom part 13 includes a design pattern 15.

In the exemplary embodiment, as indicated by the reference sign 2C in FIG. 2A, the design pattern 15 expressing an apple is formed in a continuous manner from the outer circumferential surface 11X (FIG. 2B) of the cylindrical part 11 to the outer circumferential surface 13X of the bottom part 13.

In other words, in the exemplary embodiment, the image formed on the outer circumferential surface 11X of the cylindrical part 11 (hereinafter, referred to as “cylindrical part image”) and the image formed on the outer circumferential surface 13X of the bottom part 13 (hereinafter, referred to as “bottom part image”) are formed so that the design pattern 15 included in the cylindrical part image and the design pattern 15 included in the bottom part image are continued.

Here, “forming an image” is a concept that includes just coloring, and so on, and refers to placing ink on the outer circumferential surface 11X of the cylindrical part 11 or the outer circumferential surface 13X of the bottom part 13.

When forming the image, ink may not only be applied to the entire outer surface of the beverage use can 10, but also be applied to a part of the outer surface of the beverage use can 10.

In addition, patterns, characters, character strings, pictures, graphics, and so on fall under “design pattern 15”, and those that can be distinguished from other elements fall under “design pattern 15.” In other words, “design pattern 15” refers to an element that constitutes an image formed on the outer surface of the beverage use can 10.

Moreover, continuation of the design pattern 15 in the cylindrical part image and the design pattern 15 in the bottom part image refers to the state in which the design pattern 15 is formed from the cylindrical part image to the bottom part image. In other words, the design pattern 15 is formed across the outer circumferential surface 11X of the cylindrical part 11 and the outer circumferential surface 13X of the bottom part 13.

In addition, in the exemplary embodiment, as indicated by the reference sign 2D in FIG. 2A, a character string as another example of the design pattern 15 is formed on the protection layer 13G (refer to FIG. 2B) formed on the outer circumferential surface 13X of the bottom part 13.

The character string is disposed along the circumferential direction of the beverage use can 10. To put it another way, the characters constituting the character string are arranged in the circumferential direction of the beverage use can 10.

Further, in the exemplary embodiment, as shown in FIG. 2B, a white (colored) underlayer 11E is formed on the outer circumferential surface 11X of the cylindrical part 11, and the cylindrical part image is formed on the underlayer 11E.

Note that the color of the underlayer 11E is not limited to white, and may also be any other color. The formation of the underlayer 11E reduces the influence of the metal base of the beverage use can 10, and improves the color developing property of the cylindrical part image.

On the other hand, as shown in FIG. 2B, the underlayer 11E is not formed on the outer circumferential surface 13X of the bottom part 13, and the protection layer 13G is formed on the metal base.

In this way, when the protection layer 13G is formed on the metal base, the protection layer 13G has metallic luster. In other words, the protection layer 13G has a metallic tone.

In the exemplary embodiment, on the cylindrical part 11, the metal base is shielded by the underlayer 11E, and on the bottom part 13, the underlayer 11E is not formed, and the protection layer 13G has the metallic tone.

In this case, there are portions with different color tones on the outer circumferential surface of the beverage use can 10, which makes it possible to offer a beverage use can 10 with an unprecedented outer appearance.

Note that the shielding of the metal base is not limited to the complete shielding of the metal base, but also includes the state in which the influence of the metal base is reduced.

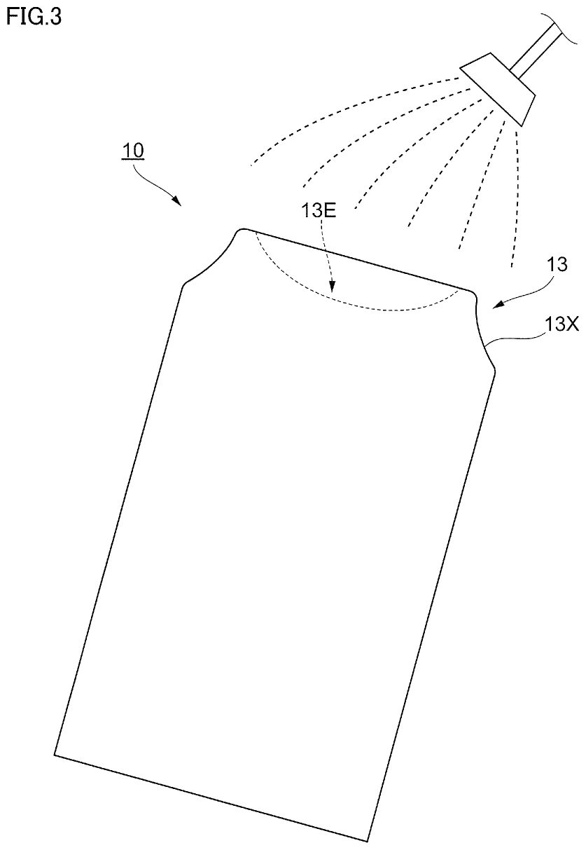

FIG. 3 is a diagram illustrating a chemical conversion treatment.

In the exemplary embodiment, prior to the formation of the underlayer 11E, the formation of the cylindrical part image, and the formation of the protection layer 13G, a chemical conversion treatment is performed on the beverage use can 10.

When the chemical conversion treatment is performed, as shown in FIG. 3, with the bottom part 13 facing upward, the liquid for the chemical conversion treatment is applied to the beverage use can 10 by means of spraying, etc.

In this case, the liquid is likely to accumulate in the concave part 13E positioned at the center portion in the radial direction of the bottom part 13, and the effect of the chemical conversion treatment increases in the concave part 13E. In contrast thereto, on the outer circumferential surface 13X of the bottom part 13, the liquid is easy to flow, and the chemical conversion treatment has a small effect.

For this reason, in the exemplary embodiment, ink is applied to the outer circumferential surface 13X of the bottom part 13. This forms the protection layer 13G (refer to FIG. 2B) on the outer circumferential surface 13X, and thereby the protection of the outer circumferential surface 13X of the bottom part 13 becomes stronger.

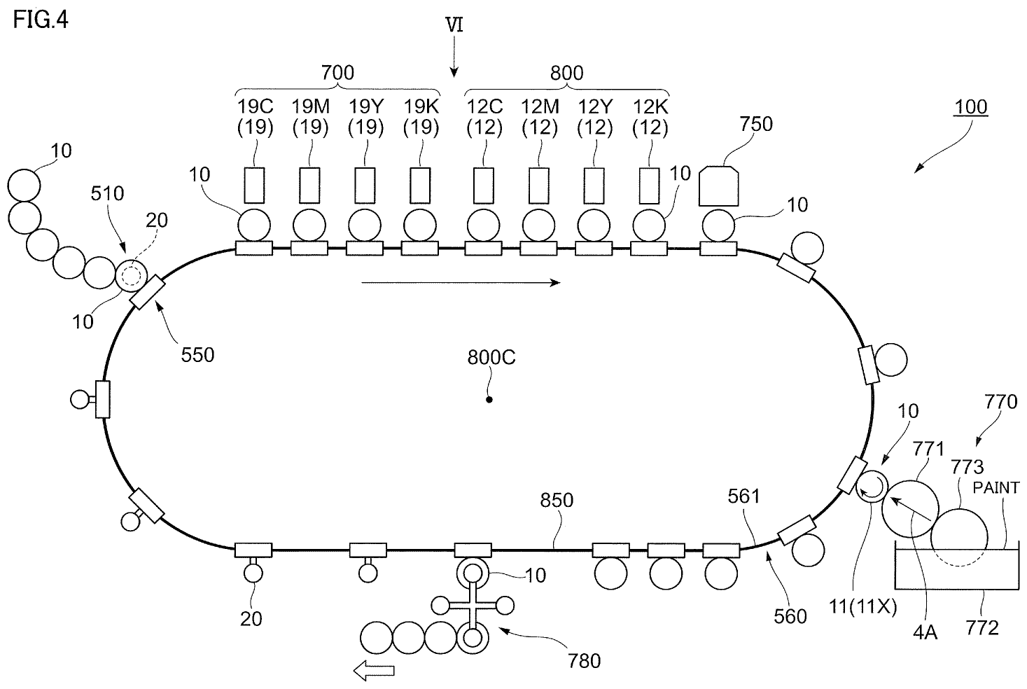

FIG. 4 is a diagram showing a printing device 100 performing printing onto the beverage use can 10.

In the exemplary embodiment, the printing device 100 forms the cylindrical part image, and forms the protection layer 13G on the outer circumferential surface 13X of the bottom part 13.

The printing device 100 is provided with a can body supply part 510 that supplies the beverage use cans 10. In the can body supply part 510, the beverage use can 10 is attached to a support member 20 that supports the beverage use can 10.

Specifically, the support member 20 is formed into a cylindrical shape, and the support member 20 is inserted into the cylindrical beverage use can 10; thereby the beverage use can 10 is attached to the support member 20.

The printing device 100 is provided with plural moving units 550, as an example of a moving body, that move while supporting the beverage use cans 10.

In the exemplary embodiment, the above-described support member 20 that supports the beverage use can 10 is attached to the moving unit 550, and thereby the beverage use can 10 moves with the moving unit 550.

Here, in the exemplary embodiment, the underlayer 11E (refer to FIG. 2B) has already been formed on the beverage use can 10 to be supplied to the support member 20.

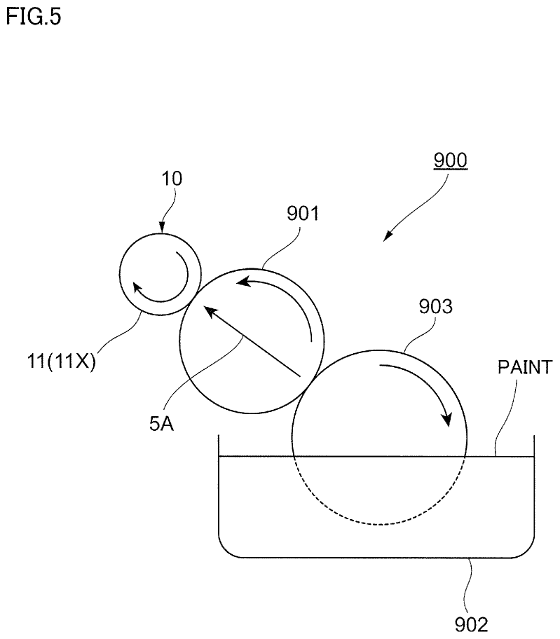

More specifically, in the exemplary embodiment, separate from the printing device 100, there is provided a paint application device 900 shown in FIG. 5 (the diagram showing the paint application device).

In the exemplary embodiment, before the printing is performed by the printing device 100, formation of the underlayer 11E onto the outer circumferential surface 11X of the cylindrical part 11 is performed by the paint application device 900.

Here, as the underlayer 11E, for example, the white underlayer 11E is formed as described above. The formation of the underlayer 11E improves the color developing property of the cylindrical part image to be formed on the underlayer 11E.

Note that, as the material constituting the underlayer 11E, those having been conventionally used may be adopted, which are not particularly limited.

Here, the paint application device 900 is provided with a contact member 901 that is formed into a cylindrical or columnar shape and is in contact with the outer circumferential surface 11X of the cylindrical part 11.

After the beverage use can 10 is supplied to a position facing the contact member 901, the contact member 901 moves toward the beverage use can 10 as indicated by the arrow 5A to come into contact with the cylindrical part 11 of the beverage use can 10.

In addition, the paint application device 900 is provided with a paint container part 902 that contains the paint, which is the source of the underlayer 11E.

Further, the paint application device 900 is provided with a supply member 903 that is formed into a cylindrical or columnar shape and supplies the paint in the paint container part 902 to the contact member 901.

In the paint application device 900, the beverage use can 10 rotates in the circumferential direction. In addition, the outer circumferential surface of the contact member 901 is supplied with the paint by the supply member 903. Consequently, in the exemplary embodiment, the paint adheres to the entire region of the outer circumferential surface 11X of the cylindrical part 11, and thereby the underlayer 11E is formed on the entire region.

Note that the contact member 901 does not come into contact with the outer circumferential surface 13X of the bottom part 13; therefore, the underlayer 11E is not formed on the outer circumferential surface 13X of the bottom part 13.

Returning to FIG. 4, the printing device 100 will be further described.

On the downstream side of the can body supply part 510, a printing part 700 is provided.

The printing part 700 uses an inkjet printing method to form an image (the cylindrical part image) onto the beverage use can 10 that has been moved from the upstream side.

The image formation using the inkjet printing method refers to printing by ejecting ink from the inkjet head and then applying the ink to the beverage use can 10.

More specifically, the inkjet head is provided with plural ejection ports that eject ink, and in the image formation by the inkjet printing method, the ink is ejected from the plural ejection ports to perform printing.

In the image formation by the inkjet printing method, publicly known systems can be used. Specifically, for example, the piezo system, the thermal (bubble) system, or the continuous system can be used.

On the downstream side of the printing part 700, a first protection layer forming part 800, as an example of a protection layer forming unit, is provided.

The first protection layer forming part 800 applies the ink onto the outer circumferential surface 13X (refer to FIG. 1A) of the bottom part 13 to form the above-described protection layer 13G on the outer circumferential surface 13X.

On the downstream side of the first protection layer forming part 800, a light irradiation part 750, as an example of a light irradiation unit, is provided.

The light irradiation part 750 includes a light source, and irradiates the beverage use can 10, after the image formation by the printing part 700 and the formation of the protection layer 13G by the first protection layer forming part 800, with light.

This cures the cylindrical part image formed on the outer circumferential surface 11X of the cylindrical part 11 and the protection layer 13G formed on the outer circumferential surface 13X of the bottom part 13.

The printing part 700 uses the ultraviolet cure ink to form the cylindrical part image. To additionally describe, the printing part 700 uses the actinic radiation cure ink to form the cylindrical part image.

In addition, the first protection layer forming part 800 also uses the ultraviolet cure ink to form the protection layer 13G.

The light irradiation part 750 irradiates the cylindrical part image formed on the outer circumferential surface 11X of the cylindrical part 11 and the protection layer 13G formed on the outer circumferential surface 13X of the bottom part 13 with ultraviolet light. This cures the cylindrical part image and the protection layer 13G.

Note that the ink used to form the cylindrical part image and the protection layer 13G is not limited to the ultraviolet cure ink, but the other types of ink, such as the thermosetting ink, may also be used.

In addition, for the formation of the cylindrical part image and the protection layer 13G, existing inks that have conventionally been used may be used (publicly known inks conventionally used for the printing on the beverage use can 10 may be used), and the inks used for forming the cylindrical part image and the protection layer 13G are not particularly limited.

Examples of the ink used for forming the cylindrical part image and the protection layer 13G include an ink containing pigments. Here, as the pigment (color material), various types of organic pigments and inorganic pigments are used. In addition, for the vehicle of the ink, a resin, such as a thermosetting resin or an ultraviolet curable resin, can be used as a main component. As the thermosetting resin, for example, an alkyd type or polyester type resin is used. In addition, as the ultraviolet curable resin, for example, an ultraviolet radical polymerization type or ultraviolet cationic polymerization type resin is used. Further, the ink may contain additive agents. Examples of the additive agent include flatting agents, waxes (natural, petroleum, synthetic), desiccants, dispersants, wetting agents, cross-linking agents, gelatinizing agents, thickeners, anti-skinning agents, stabilizers, anti-foaming agents, and photopolymerization initiators.

Further, in the exemplary embodiment, a second protection layer forming part 770 is provided.

The second protection layer formation part 770 is disposed on the downstream side of the first protection layer forming part 800 in the moving direction of the beverage use can 10.

The second protection layer forming part 770 forms a transparent layer, which covers the cylindrical part image, on the cylindrical part image. Consequently, in the exemplary embodiment, the transparent protection layer 11G (refer to FIG. 2B) is formed on the outermost layer of the cylindrical part 11.

The second protective layer forming part 770 is configured in the same way as the paint application device 900 shown in FIG. 5.

The second protection layer forming part 770 is provided with a contact member 771 that is formed into a cylindrical or columnar shape and is in contact with the outer circumferential surface 11X of the cylindrical part 11.

After the beverage use can 10 is supplied to a position facing the contact member 771, the contact member 771 moves toward the beverage use can 10 to come into contact with the cylindrical part 11. More specifically, the contact member 771 moves as indicated by the arrow 4A in the figure and comes into contact with the cylindrical part 11.

In addition, the second protection layer forming part 770 is provided with a paint container part 772 that contains paint. Further, the second protection layer forming part 770 is provided with a supply member 773 that is formed into a cylindrical or columnar shape and supplies the paint in the paint container part 772 to the contact member 771.

In the second protection layer forming part 770, the beverage use can rotates in the circumferential direction. In addition, the outer circumferential surface of the contact member 771 is supplied with the paint by the supply member 773.

Consequently, in the exemplary embodiment, the paint adheres to the entire region of the outer circumferential surface 11X of the cylindrical part 11. This forms the transparent protection layer 11G (refer to FIG. 2B) on the cylindrical part 11.

Note that, similar to the above, the contact member 771 does not come into contact with the outer circumferential surface 13X of the bottom part 13; therefore, the protection layer 11G (the protection layer by the transparent paint) is not formed on the outer circumferential surface 13X of the bottom part 13.

On the downstream side of the second protection layer forming part 770, a detachment part 780, which detaches the beverage use can 10 from the support member 20, is provided.

In the exemplary embodiment, the beverage use can 10 is detached from the support member 20 at the detachment part 780, and the beverage use can 10 is discharged to the outside of the printing device 100.

In the exemplary embodiment, the beverage use can 10 discharged to the outside of the printing device 100 is heated by a heating device (not shown). This cures the above-described protection layer 11G (the transparent protection layer 11G) formed on the outermost layer of the cylindrical part 11.

As described above, the printing device 100 is provided with the plural moving units 550, as an example of the moving body.

In the exemplary embodiment, the beverage use cans 10 are supported by the moving units 550, and thereby the beverage use cans 10 move with the moving units 550.

In the exemplary embodiment, a moving mechanism 560, which functions as a mover unit for moving the moving units 550, is provided. The moving mechanism 560 is provided with an annular-shaped guide member 561 that guides the moving units 550.

Each of the moving units 550 is guided by the guide member 561 to orbitally move along a predetermined annular moving route 850.

In addition, inside the guidance member 561, electromagnets (not shown) are provided. Further, a permanent magnet (not shown) is installed to the moving unit 550. In the exemplary embodiment, the linear mechanism is used to move the moving unit 550.

Note that the moving unit 550 can be moved by other mechanisms, not only by the linear mechanism. For example, there may be a configuration in which a motor is provided to the moving unit 550, and thereby the moving unit 550 moves autonomously.

The moving units 550 move along the predetermined annular moving route 850.

The moving route 850 is disposed so that the axial center 800C thereof extends along the horizontal direction. In other words, the moving route 850 is disposed around the axial center 800C along the horizontal direction. Here, the axial center 800C extends in a direction perpendicular to the page in FIG. 4.

Then, in this case, in the exemplary embodiment, the moving unit 550 orbitally moves around the axial center 800C, which extends along the direction perpendicular to the page in the figure.

Note that, in the exemplary embodiment, description was given by taking the case, in which the annular moving route 850 is disposed around the axial center 800C along the horizontal direction, as an example; however, not limited thereto, the annular moving route 850 may be disposed around an axial center along the vertical direction.

Moreover, in the exemplary embodiment, the moving route of the moving units 550 from the printing part 700 to the first protection layer forming part 800 was linear; however, not limited thereto, the moving route may be formed into a curved shape, such as an arc.

The printing part 700 will be described in detail.

The printing part 700 is provided with plural inkjet heads 19 arranged in the horizontal direction in the figure. The portion where the plural inkjet heads 19 are provided can be grasped as an image forming unit that performs image formation onto the outer circumferential surface 11X of the cylindrical part 11.

Specifically, the printing part 700 is provided with a first inkjet head 19C that ejects cyan ink, a second inkjet head 19M that ejects magenta ink, a third inkjet head 19Y that ejects yellow ink, and a fourth inkjet head 19K that ejects black ink.

In the following descriptions, in the case where the first inkjet head 19C to the fourth inkjet head 19K are not particularly distinguished, these inkjet heads are simply referred to as “inkjet heads 19.”

Here, the four inkjet heads 19, namely, the first inkjet head 19C to the fourth inkjet head 19K, use the ultraviolet cure ink to perform image formation onto the outer circumferential surface 11X of the cylindrical part 11.

In addition, in the exemplary embodiment, the beverage use can 10 moves in a state of being laid (the beverage use can 10 moves in a state in which the axial direction of the beverage use can 10 extends horizontally), and a part of the outer circumferential surface of the beverage use can 10 faces upward in the vertical direction. In the exemplary embodiment, the ink is ejected downwardly from above the outer circumferential surface, to thereby perform image formation onto the outer circumferential surface 11X of the cylindrical part 11.

Further, in the exemplary embodiment, the four inkjet heads 19 are arranged in the moving direction of the beverage use can 10. In addition, each of the four inkjet heads 19 is disposed along a direction perpendicular to (crossing) the moving direction of the beverage use can 10.

In the exemplary embodiment, in a process in which the beverage use can 10 passes below the four inkjet heads 19, the ink is ejected to the cylindrical part 11 from above. Consequently, the cylindrical part image is formed on the outer circumferential surface 11X of the cylindrical part 11.

More specifically, in the exemplary embodiment, the moving unit 550 stops at the installation location of each of the plural inkjet heads 19 that have been provided. Then, in each of the inkjet heads 19, the ink is ejected to the cylindrical part 11, to thereby form the cylindrical part image on the outer circumferential surface 11X of the cylindrical part 11.

Note that, when the image formation is performed in each of the inkjet heads 19, the beverage use can 10 rotates in the circumferential direction.

More specifically, in the exemplary embodiment, the beverage use can 10 rotates in the circumferential direction by a driving source, such as a motor, provided in each of the moving units 550.

Note that the driving source is not limited to those provided to the moving unit 550; for example, there may be a configuration in which the driving source is provided to the main body side of the printing device 100, and the driving force is transmitted from the driving source provided to the main body side to the moving unit 550.

In addition, in the exemplary embodiment, the case in which the four inkjet heads 19 are provided to the printing part 700 is shown as an example; however, an inkjet head 19 that ejects ink of a special color, such as a corporate color, may be added.

Moreover, in the moving direction of the beverage use can 10, an inkjet head 19 for forming the above-described underlayer 11E (refer to FIG. 2B) may be provided on the upstream side of the printing part 700.

The formation of the underlayer 11E is not limited to the stage prior to the introduction of beverage use cans 10 to the printing device 100, but it may also be possible to provide the inkjet head 19 for forming the underlayer 11E to the printing device 100, and to form the underlayer 11E by the inkjet head 19.

Similar to the printing part 700, the first protection layer forming part 800 is provided with four inkjet heads 12.

In other words, a first inkjet head 12C that ejects cyan ink, a second inkjet head 12M that ejects magenta ink, a third inkjet head 12Y that ejects yellow ink, and a fourth inkjet head 12K that ejects black ink are provided.

Here, the four inkjet heads 12, namely, the first inkjet head 12C to the fourth inkjet head 12K, eject the ultraviolet cure ink toward the outer circumferential surface 13X of the bottom part 13, to thereby form the protection layer 13G (refer to FIG. 2B) on the outer circumferential surface 13X.

In addition, in the exemplary embodiment, the ink is ejected downwardly from above the outer circumferential surface 13X of the bottom part 13, to thereby form the protection layer 13G onto the outer circumferential surface 13X of the bottom part 13.

Further, in the exemplary embodiment, the four inkjet heads 12 are arranged in the moving direction of the beverage use can 10. In addition, each of the four inkjet heads 12 is disposed along a direction perpendicular to (crossing) the moving direction of the beverage use can 10.

In the exemplary embodiment, in a process in which the beverage use can 10 passes below the four inkjet heads 12, the ink is ejected to the outer circumferential surface 13X of the bottom part 13 from above. Consequently, the protection layer 13G is formed on the outer circumferential surface 13X of the bottom part 13.

More specifically, in the exemplary embodiment, the moving unit 550 stops at the installation location of each of the plural inkjet heads 12 that have been provided.

Then, in each of the inkjet heads 12, the ink is ejected to the outer circumferential surface 13X of the bottom part 13, to thereby form the protection layer 13G on the outer circumferential surface 13X of the bottom part 13. Note that, when the ink is ejected from each of the inkjet heads 12, the beverage use can 10 rotates in the circumferential direction.

Here, in the exemplary embodiment, description was given of the case in which the four inkjet heads 12 were provided to the first protection layer forming part 800; however, similar to the above, an inkjet head 12 that ejects ink of a special color, such as a corporate color, may be added.

Moreover, the first protection layer forming part 800 may further be provided with an inkjet head 12 for forming the underlayer (for example, the white underlayer).

The formation of the underlayer on the outer circumferential surface 13X of the bottom part 13 improves the color developing property of the protection layer 13G to be formed on the outer circumferential surface 13X. Here, the color of the underlayer is not limited to white, but may be any other color.

Note that, in the case where the inkjet head 12 for forming the underlayer is installed, the inkjet head 12 for forming the underlayer is installed on the upstream side of the above four inkjet heads 12.

Each of the moving units 550, as an example of a moving body, moves at a predetermined moving speed.

In addition, each of the moving units 550 stops at each of the can body supply part 510, the printing part 700, the first protection layer forming part 800, the light irradiation part 750, the second protection layer forming part 770, and the detachment part 780.

Moreover, at each of the printing part 700, the first protection layer forming part 800, the light irradiation part 750, the second protection layer forming part 770, and the like, the beverage use can 10 on the moving unit 550 rotates in the circumferential direction at the predetermined rotation speed.

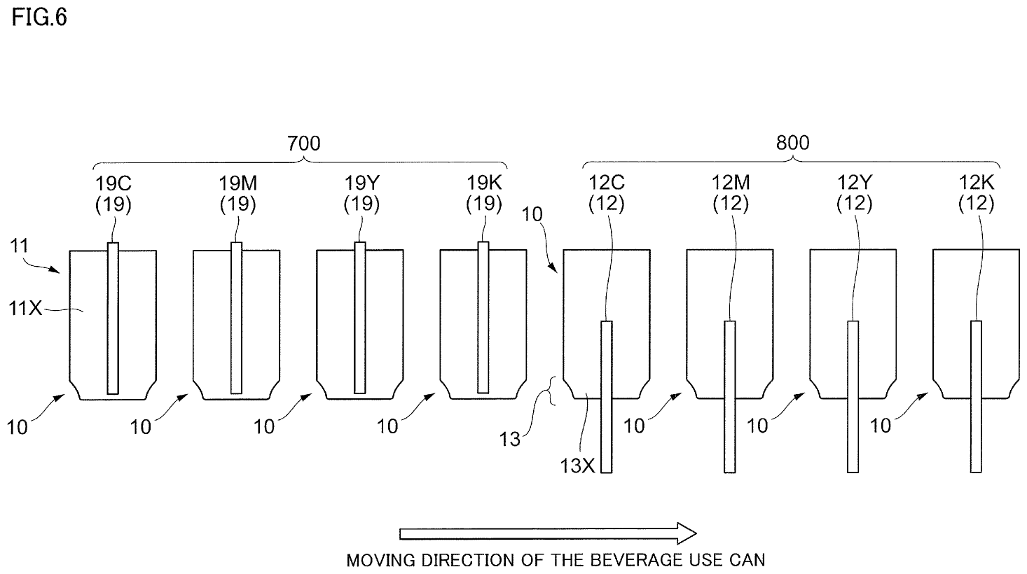

FIG. 6 is a diagram in the case where the printing part 700 and the first protection layer forming part 800 are viewed from the direction indicated by the arrow VI in FIG. 4.

In the exemplary embodiment, as described above, the printing part 700 is provided with the four inkjet heads 19, the first inkjet head 19C to the fourth inkjet head 19K.

In addition, the first protection layer forming part 800 is provided with the four inkjet heads 12, the first inkjet head 12C to the fourth inkjet head 12K.

In the exemplary embodiment, as described above, the printing part 700 forms the cylindrical part image on the outer circumferential surface 11X of the cylindrical part 11.

More specifically, the four inkjet heads 19 are used to form the cylindrical part image composed of inks of plural colors on the outer circumferential surface 11X of the cylindrical part 11.

In addition, in the exemplary embodiment, the first protection layer forming part 800 forms the protection layer 13G onto the outer circumferential surface 13X of the bottom part 13.

More specifically, in the first protection layer forming part 800, one or more inkjet heads 12 included in the four inkjet heads 12 are used to form the protection layer 13G onto the outer circumferential surface 13X of the bottom part 13.

More specifically, the ink ejected from the one or more inkjet heads 12 is cured, and thereby the protection layer 13G composed of the cured ink is formed.

In the exemplary embodiment, the printing part 700 forms the cylindrical part image composed of the inks of plural colors on the outer circumferential surface 11X of the cylindrical part 11.

On the other hand, in the first protection layer forming part 800, it is not necessary to use the plural inkjet heads 12; for example, one inkjet head 12 may be used to form the protection layer 13G onto the outer circumferential surface 13X of the bottom part 13.

In other words, in the exemplary embodiment, the printing part 700 uses plural colors to perform image formation, but in the first protection layer forming part 800, the protection layer 13G may be formed by applying ink of part of the plural colors to the outer circumferential surface 13X of the bottom part 13.

To put it another way, the printing part 700 uses the plural inkjet heads 19 to perform image formation, but in the first protection layer forming part 800, the protection layer 13G may be formed by using the inkjet heads 12 that are fewer in number than the inkjet heads 19 used in the printing part 700.

More specifically, in the exemplary embodiment, for example, in the printing part 700, image formation is performed by using inks of four colors, cyan, yellow, magenta, and black; while in the first protection layer forming part 800, the protection layer 13G may be formed by using, for example, only the yellow ink.

In this case, the amount of ink to be used is reduced as compared to the case in which the protection layer 13G is formed by using the inks of four colors.

In addition, in the first protection layer forming part 800, the protection layer 13G may be formed by using the inkjet heads 12 in the same number as the inkjet heads 19 used in the printing part 700.

In addition, when the cylindrical part image and the protection layer 13G are formed, the background color in the cylindrical part image and the background color in the protection layer 13G may be the same as shown in FIG. 2A.

Here, the background color refers to the color of the image formed in the region excluding the design pattern 15.

In the example shown in FIG. 2A, each of the design patterns 15 is provided with a predetermined color for each design pattern 15, and the background portions 2T (the background portion in the cylindrical part image) and 2S (the background portion in the protection layer 13G) excluding the design patterns 15 have the same color.

Here, in the exemplary embodiment, of the inkjet head 19 or 12, the total length of the region where the ink ejection ports (not shown) are formed is shorter than the total length of the beverage use can 10. In this case, it becomes difficult to perform image formation onto the entire region in the axial direction of the beverage use can 10 by a single inkjet head 19 or 12.

For this reason, in the exemplary embodiment, separate from the inkjet head 19 for forming the cylindrical part image onto the outer circumferential surface 11X of the cylindrical part 11, the inkjet head 12 for forming the protection layer 13G onto the outer circumferential surface 13X of the bottom part 13 is provided, as shown in FIG. 6.

In the exemplary embodiment, in the case where positions in the axial direction of the beverage use can 10 are compared, the position of each of the inkjet heads 19 installed in the printing part 700 and the position of each of the inkjet heads 12 installed in the first protection layer forming part 800 are shifted from each other.

More specifically, in the exemplary embodiment, the inkjet head 12 installed in the first protection layer forming part 800 is disposed closer to the bottom part 13 of the beverage use can 10 than the inkjet head 19 installed in the printing part 700.

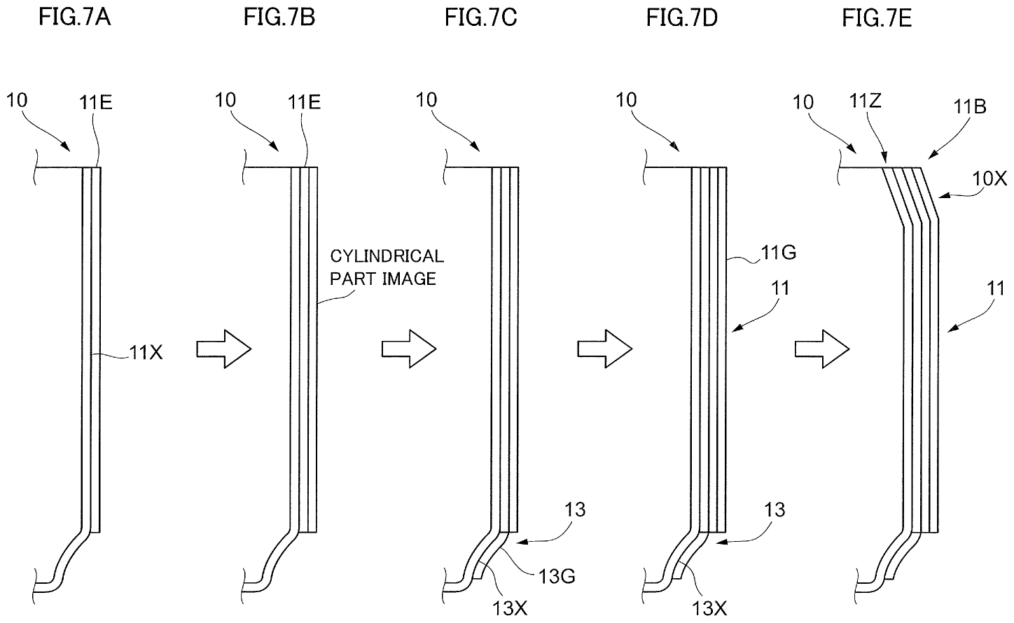

FIG. 7 shows diagrams indicating the changes in the cross-sectional structure of the beverage use can 10. FIG. 7 shows the changes in the cross-sectional structure from the stage of the base can. In addition, FIG. 7 shows the changes in the cross-sectional structure of the portion indicated by the reference sign IIB in FIG. 2A.

In the exemplary embodiment, first, as described above, the contact member 901 (refer to FIG. 5) formed into the cylindrical or columnar shape is pressed against the outer circumferential surface of the beverage use can 10 after the chemical conversion treatment.

Consequently, as shown in FIG. 7A, the white underlayer 11E is formed on the outer circumferential surface 11X of the cylindrical part 11. In this example, before supplying the beverage use can 10 to the printing device 100, the underlayer 11E is formed onto the outer circumferential surface 11X of the cylindrical part 11.

Next, in the exemplary embodiment, the cylindrical part image is formed on the underlayer 11E by the printing part 700 as shown in FIG. 7B.

Next, in the exemplary embodiment, the protection layer 13G is formed on the outer circumferential surface 13X of the bottom part 13 by the first protection layer forming part 800 as shown in FIG. 7C.

Note that, in the exemplary embodiment, description was given of the case in which the cylindrical part image was formed earlier and the protection layer 13G was formed later; however, the order of formation is not limited thereto, and the protection layer 13G may be formed earlier and the cylindrical part image may be formed later.

Next, in the exemplary embodiment, the transparent protection layer 11G is formed on the outermost layer of the cylindrical part 11 by the second protection layer forming part 770 as shown in FIG. 7D.

Consequently, the beverage use can 10 in the state shown in FIGS. 2A and 2B is formed.

Note that, in the exemplary embodiment, the transparent protection layer 11G is not formed on the outer circumferential surface 13X of the bottom part 13 as described above.

Thereafter, in the exemplary embodiment, the so-called neck processing is performed, to thereby form a diameter decreased part 10X at the other end portion 11B of the cylindrical part 11 as shown in FIG. 7E.

Here, “diameter decreased part 10X” refers to the portion where the outer diameter of the cylindrical part 11 gradually decreases with the move from the center portion side toward the opening edge 11Z side in the axial direction of the cylindrical part 11.

In the exemplary embodiment, the processing on the beverage use can 10 is performed to form the diameter decreased part 10X by a device provided separately from the printing device 100.

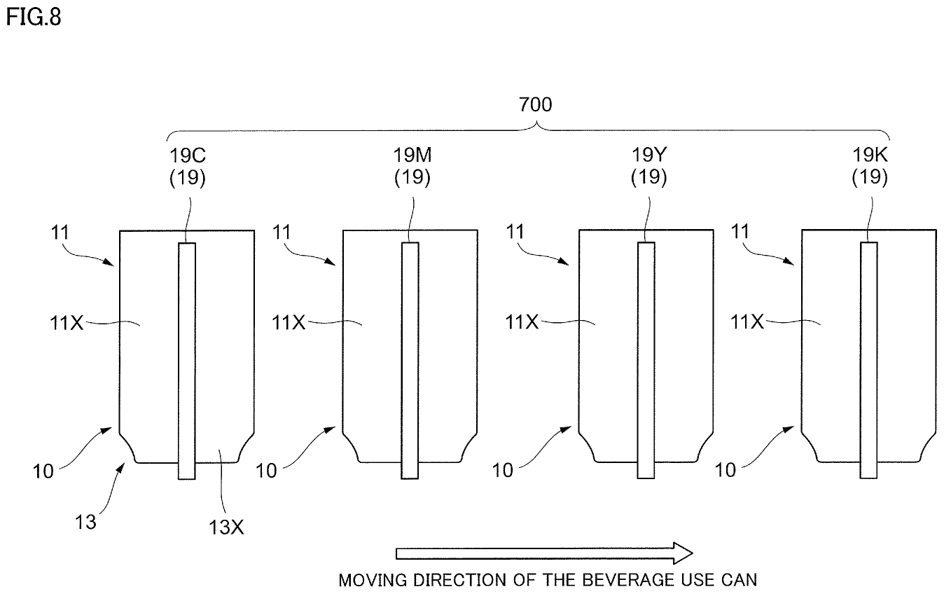

FIG. 8 is a diagram showing still another configuration example of the printing part 700, in which the printing part 700 is viewed from above.

In the configuration example, similar to the above, of the inkjet head 19, the total length of the region where the ink ejection ports (not shown) are formed is shorter than the total length of the beverage use can 10.

Further, in the configuration example, the inkjet head 19 is disposed closer to the bottom part 13 of the beverage use can 10.

Then, in this configuration example, when the cylindrical part image is formed on the outer circumferential surface 11X of the cylindrical part 11 by using the inkjet heads 19, the ink is also ejected to the outer circumferential surface 13X of the bottom part 13 from the inkjet heads 19, to thereby form the protection layer 13G on the outer circumferential surface 13X.

In other words, in the configuration example, the formation of the cylindrical part image onto the outer circumferential surface 11X and the formation of the protection layer 13G onto the outer circumferential surface 13X by use of the common inkjet heads 19.

In the configuration example, there is no inkjet head dedicated to form the protection layer 13G; thereby, the number of inkjet heads to be installed is reduced.

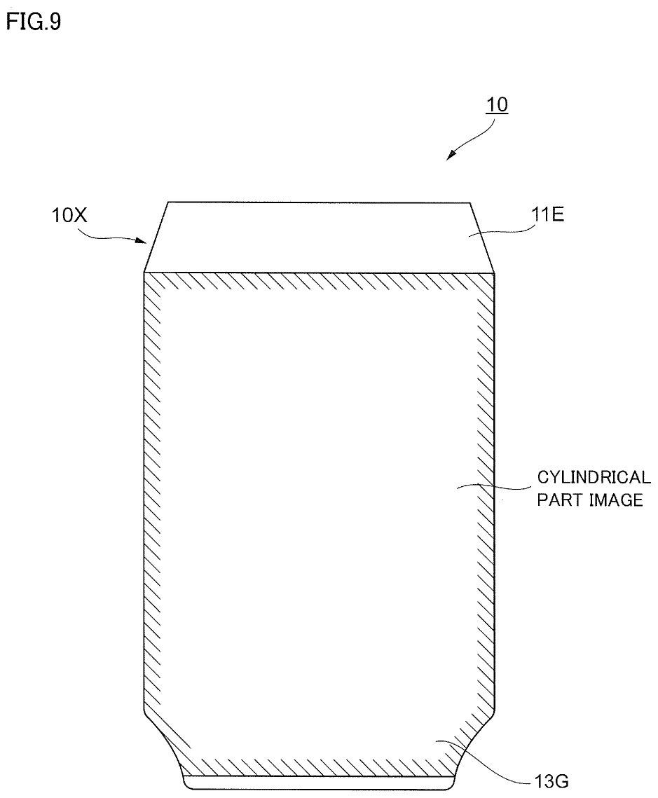

In addition, in the configuration example, when the beverage use can 10 is finally completed, the cylindrical part image is not formed on the diameter decreased part 10X, as shown in FIG. 9 (the diagram showing another configuration example of the beverage use can 10), and the underlayer 11E appears on at least part of the diameter decreased part 10X.

To additionally describe, in the configuration example, the underlayer 11E appears on the diameter decreased part 10X, where the white solid-color image is formed. In this case, it is possible to offer a beverage use can 10 with an unprecedented outer appearance.

Note that it is not necessary to form the underlayer 11E, and in the case where the underlayer 11E is not formed, a metal base appears on the diameter decreased part 10X. In this case, it is also possible to offer a beverage use can 10 with an unprecedented outer appearance.

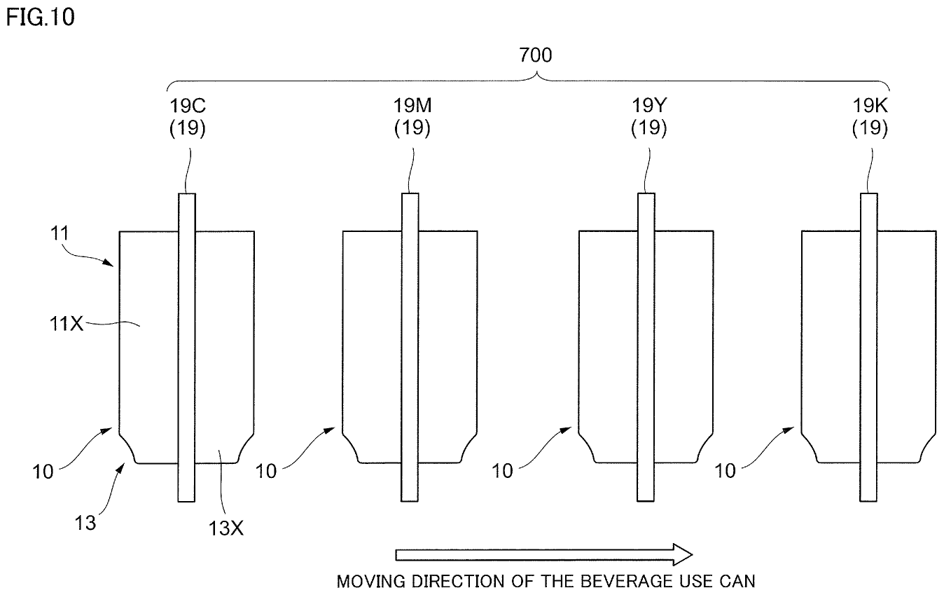

FIG. 10 is a diagram showing still another configuration example of the printing part 700, in which the printing part 700 is viewed from above.

In the configuration example, the inkjet head 19 is longer than that in the exemplary embodiment shown in the above; in the configuration example, a single inkjet head 19 can eject the ink onto the outer circumferential surface 11X of the cylindrical part 11 and the outer circumferential surface 13X of the bottom part 13.

In the configuration example, similar to the configuration example shown in FIG. 8, the ink is applied to the outer circumferential surface 13X to form the protection layer 13G when the cylindrical part image is formed on the outer circumferential surface 11X by using the common inkjet head 19.

In the configuration example, the inkjet head 19 is also provided at the position facing the portion of the cylindrical part 11, which serves as the diameter decreased part 10X; in the configuration example, different from the configuration example shown in FIG. 8, it is also possible to form the cylindrical part image onto the portion serving as the diameter decreased part 10X.

To additionally describe, in the configuration example shown in FIG. 10, similar to the configuration example shown in FIG. 8, the protection layer 13G can be formed on the outer circumferential surface 13X by using the inkjet head 19, which is the image forming unit that forms the image onto the outer circumferential surface 11X.

More specifically, in the configuration example, the protection layer 13G is formed on the outer circumferential surface 13X by using one or more inkjet heads 19 included in the four inkjet heads 19 used for performing image formation onto the outer circumferential surface 11X.

Here, when the ink is applied to the outer circumferential surface 13X (when the protection layer 13G is formed), it is unnecessary to use all the four inkjet heads 19, but at least one inkjet head 19 is required.

In other words, when the ink is applied to the outer circumferential surface 13X, ink of part of the plural colors should be applied to the outer circumferential surface 13X to form the protection layer 13G.

Specifically, in the exemplary embodiment, for example, an image composed of inks of four colors is formed on the outer circumferential surface 11X; however, it is unnecessary to use all the four colors, and the protection layer 13G may be formed by only one color, for example.

In addition, similar to the above, when the protection layer 13G is formed, the background color in the protection layer 13G and the background color in the cylindrical part image formed on the cylindrical part 11 may be the same.

Moreover, when the ink is ejected to the outer circumferential surface 13X, the ink may be ejected from the inkjet head 19 to the outer circumferential surface 13X before or after the ink ejection from the inkjet head 19 toward the outer circumferential surface 11X.

In other words, the ejection timing for ejecting ink toward the outer circumferential surface 11X and the timing for ejecting ink toward the outer circumferential surface 13X may be different.

Next, ejection conditions in ejecting ink will be described.

When the cylindrical part image and the protection layer 13G are formed by using only the inkjet head 19, or both the inkjet heads 19 and 12, the ink ejection conditions in ejecting ink from the inkjet head to the outer circumferential surface 11X may be different from the ejection conditions in ejecting ink from the inkjet head to the outer circumferential surface 13X.

Specifically, in the exemplary embodiment, the cylindrical part image and the protection layer 13G are formed by using the inkjet head 12 dedicated for forming the protection layer 13G as shown in FIG. 6, or by using the common inkjet head 19 as shown in FIGS. 8 and 10.

When the cylindrical part image and the protection layer 13G are formed, the ink ejection conditions in ejecting ink from the inkjet head to the outer circumferential surface 11X may be different from the ejection conditions in ejecting ink from the inkjet head to the outer circumferential surface 13X.

More specifically, for example, the amount of ink per a single droplet in ejecting ink from the inkjet head to the outer circumferential surface 11X may be different from the amount of ink per a single droplet in ejecting ink from the inkjet head to the outer circumferential surface 13X.

More specifically, for example, the amount of ink per a single droplet in ejecting ink from the inkjet head to the outer circumferential surface 13X may be larger than the amount of ink per a single droplet in ejecting ink from the inkjet head to the outer circumferential surface 11X.

Moreover, in contrast thereto, the amount of ink per a single droplet in ejecting ink from the inkjet head to the outer circumferential surface 13X may be smaller than the amount of ink per a single droplet in ejecting ink from the inkjet head to the outer circumferential surface 11X.

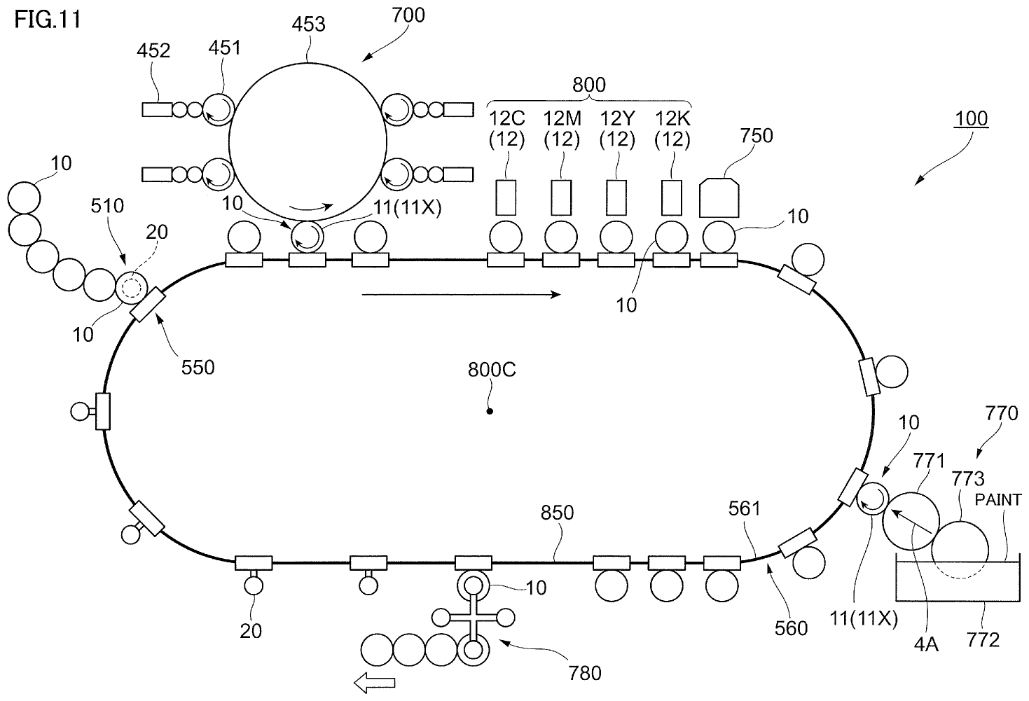

FIG. 11 is a diagram showing another configuration example of the printing device 100.

Similar to the above, the printing device 100 is provided with the printing part 700; however, in the printing part 700, the ink is applied to the outer circumferential surface 11X of the cylindrical part 11 by using the plate printing method, to thereby form the cylindrical part image on the outer circumferential surface 11X.

In other words, in the printing device 100, by use of the plate printing method, the cylindrical part image is formed on the outer circumferential surface 11X of the cylindrical part 11.

Specifically, the printing part 700 in the configuration example is provided with plural plate cylinders 451. On the surface of the plate cylinder 451, convex portions (not shown) corresponding to the cylindrical part image are provided. In addition, the printing part 700 is provided with plural ink supply units 452 supplying ink to the convex portions of the plate cylinders 451.

Further, the printing part 700 is provided with a blanket 453 to which the ink from the plate cylinders 451 is transferred and which transfers the ink to the outer circumferential surface 11X of the cylindrical part 11.

In the printing part 700, the beverage use can 10 stops at a position facing the blanket 453. Further, the beverage use can 10 rotates in the circumferential direction.

In addition, in the printing part 700, ink is supplied from each of the ink supply units 452 to the surface of the corresponding plate cylinder 451. Then, the ink adhered to the surfaces of the plate cylinders 451 (the ink adhered to the convex portions of the plate cylinders 451) is transferred to the blanket 453.

Further, the ink transferred to the blanket 453 is transferred to the cylindrical part 11 of the rotating beverage use can 10. Consequently, the cylindrical part image is formed on the outer circumferential surface 11X of the cylindrical part 11. In other words, the cylindrical part image by the plate printing method is formed.

Here, image formation by the plate printing method refers to image formation by use of plates. More specifically, the image formation by the plate printing method refers to image formation onto the beverage use can 10 performed by applying ink to the plates and then transferring the ink applied to the plates to the beverage use can 10.

Note that the transfer may be performed by bringing the plates and the beverage use can 10 into direct contact, or an intermediate transfer body, such as the blanket 453, may be disposed between the plates and the beverage use can 10, to thereby perform the transfer onto the beverage use can 10.

Here, examples of printing by the plate printing method include relief printing, intaglio printing, planographic printing and stencil printing, and any of these may be used in printing by the plate printing method. Note that, in the exemplary embodiment, image formation onto the beverage use can 10 is performed by use of the relief printing.

On the other hand, in the first protection layer forming part 800 (in the process for forming the protection layer 13G) in the printing device 100, similar to the above, the protection layer 13G is formed by applying the ink onto the outer circumferential surface 13X by using the inkjet head method.

In the printing device 100 shown in FIG. 11, the method for applying the ink onto the outer circumferential surface 11X is different from the method for applying the ink onto the outer circumferential surface 13X.

More specifically, in the print part 700 (image forming process), the ink is applied to the outer circumferential surface 11X using the plate printing method, which is one of the ink application methods.

In contrast thereto, in the first protection layer forming part 800 (protection layer forming process), the ink is applied to the outer circumferential surface 13X by using the inkjet method, which is another ink application method different from the one ink application method.

In this way, when the ink is applied to the outer circumferential surface 11X and when the ink is applied to the outer circumferential surface 13X, the application of the ink to the outer circumferential surface 11X and the application of the ink to the outer circumferential surface 13X may be performed by using the methods different from each other.

Note that, in the configuration example shown in FIG. 11, the single printing device 100 is provided with two functional parts, namely, a functional part that forms the cylindrical part image by the plate printing method and a functional part that forms the protection layer 13G by the inkjet method; however, the two functional parts may be provided to respective different devices.

In this case, for example, the formation of the cylindrical part image by the plate printing method is performed by a device that has a function of performing printing by the plate printing method. Next, the formation of the protection layer 13G is performed by the other device that has a function of performing printing by the inkjet method.

Note that the order of formation is not limited thereto, and the protection layer 13G may be formed earlier and the cylindrical part image may be formed later.

### (Others)

In the above, description was given to the case in which the protection layer 13G was formed by using the inkjet method, but not limited thereto, the ink may be applied to the outer circumferential surface 13X using other methods, such as the plate printing method, to thereby form the protection layer 13G.

In addition, in the above, description was given by taking the case, in which the inkjet heads 19 and 12 that formed the protection layer 13G onto the outer circumferential surface 13X were disposed along the axial direction of the beverage use can 10, as an example.

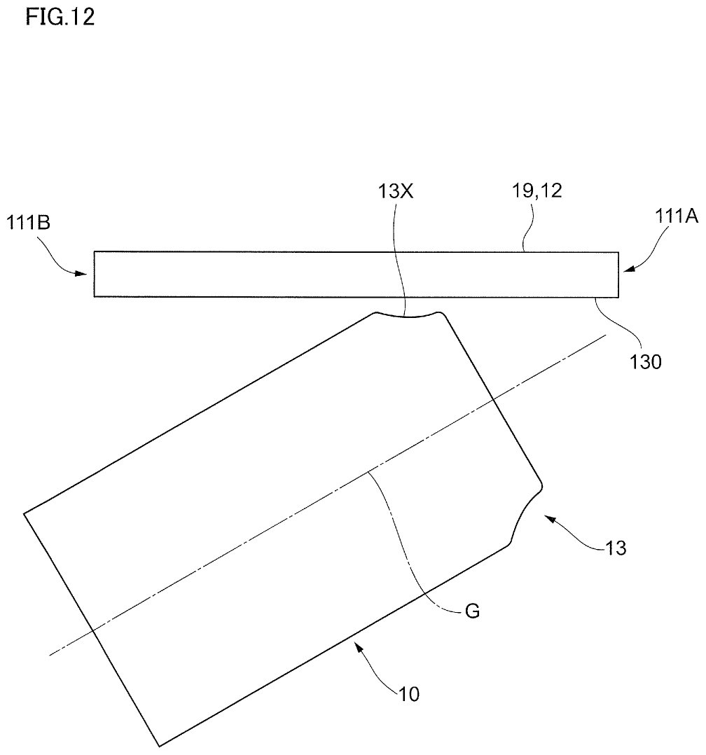

By the way, the disposition of the inkjet heads 19 and 12 is not limited thereto, and the inkjet heads 19 and 12 may be disposed as shown in FIG. 12 (the diagram showing another disposition example of the inkjet heads).

In the disposition example shown in FIG. 12, the inkjet heads 19 and 12 are provided so that the surface 130 of the inkjet heads 19 and 12 where the ink ejection ports are formed is inclined with respect to the central axis G of the beverage use can 10.

In this case, the inkjet heads 19 and 12 can be placed closer to the outer circumferential surface 13X of the bottom part 13, and thereby the image to be formed on the outer circumferential surface 13X can be a higher-resolution image.

Note that, to incline the surface 130 with respect to the central axis G, for example, the beverage use can 10 is inclined so that the central axis G of the beverage use can 10 is inclined with respect to the horizontal direction. Alternatively, the inkjet heads 19 and 12 are inclined so that the surface 130 is inclined with respect to the horizontal direction.

In addition, both the beverage use can 10 and the inkjet heads 19 and 12 may be inclined with respect to the horizontal direction.

### REFERENCE SIGNS LIST

10 Beverage use can
11 Cylindrical part
11A One end portion
11B The other end portion
11E Underlayer
11X Outer circumferential surface
13 Bottom part
13G Protection layer
13X Outer circumferential surface
15 Design pattern
19 Inkjet head
100 Printing device
800 First protection layer forming part

1. A method for forming a beverage use can provided with a cylindrical part with one end portion and the other end portion, and a bottom part positioned at the one end portion of the cylindrical part, the bottom part having an outer circumferential surface with an outer diameter gradually increasing with a move toward the other end portion of the cylindrical part, the method comprising:
a protection layer forming process applying ink to the outer circumferential surface of the bottom part to form a protection layer on the outer circumferential surface.

2. The method for manufacturing a beverage use can according to claim 1, wherein, when an image is formed on an outer circumferential surface of the cylindrical part by using ink, the protection layer is formed by applying ink on the outer circumferential surface of the bottom part.

3. The method for manufacturing a beverage use can according to claim 1, wherein the protection layer is formed by applying ink on the outer circumferential surface of the bottom part by using an image forming unit forming an image on an outer circumferential surface of the cylindrical part.

4. The method for manufacturing a beverage use can according to claim 1, further comprising:
an image forming process forming an image on an outer circumferential surface of the cylindrical part, wherein
formation of an image in the image forming process and application of ink to the outer circumferential surface in the protection layer forming process are performed by a common inkjet head.

5. The method for manufacturing a beverage use can according to claim 1, wherein
ink is ejected from an inkjet head to an outer circumferential surface of the cylindrical part to form an image on the outer circumferential surface, and ink is ejected from an inkjet head to the outer circumferential surface of the bottom part to form the protection layer, and
an ink ejection condition when ink is ejected from the inkjet head to the outer circumferential surface of the cylindrical part is different from an ejection condition when ink is ejected from the inkjet head to the outer circumferential surface of the bottom part.

6. The method for manufacturing a beverage use can according to claim 5, wherein an amount of ink per a single droplet when ink is ejected from the inkjet head to the outer circumferential surface of the cylindrical part is different from an amount of ink per a single droplet when ink is ejected from the inkjet head to the outer circumferential surface of the bottom part.

7. The method for manufacturing a beverage use can according to claim 1, wherein
an image is formed on the outer circumferential surface of the bottom part by applying the ink to the outer circumferential surface, and
a bottom part image, which is an image formed on the outer circumferential surface of the bottom part, is formed to cause a design pattern included in the bottom part image to continue to a design pattern included in a cylindrical part image, which is an image formed on an outer circumferential surface of the cylindrical part.

8. The method for manufacturing a beverage use can according to claim 1, wherein
an image composed of inks of plural colors is formed on an outer circumferential surface of the cylindrical part, and,
in the protection layer forming process, ink of part of the plural colors is applied to the outer circumferential surface of the bottom part to form the protection layer.

9. The method for manufacturing a beverage use can according to claim 1, further comprising:
an image forming process forming an image on an outer circumferential surface of the cylindrical part, wherein,
in the image forming process, a colored underlayer is formed on the outer circumferential surface of the cylindrical part, and then ink is applied on the colored underlayer to form an image on the underlayer,
the beverage use can is made of metal, and,
in the protection layer forming process, ink is applied onto a metal base positioned on the outer circumferential surface of the bottom part to form the protection layer on the outer circumferential surface of the bottom part.

10. The method for manufacturing a beverage use can according to claim 1, further comprising:
an image forming process applying ink to an outer circumferential surface of the cylindrical part by using one ink application method and forming an image on the outer circumferential surface, wherein,
in the protection layer forming process, ink is applied to the outer circumferential surface of the bottom part by using another ink application method, which is different from the one ink application method, to form the protection layer.

11. The method for manufacturing a beverage use can according to claim 10, wherein,
in the image forming process, ink is applied to the outer circumferential surface of the cylindrical part by using a plate printing method to form an image on the outer circumferential surface, and,
in the protection layer forming process, ink is applied to the outer circumferential surface of the bottom part by using an inkjet head method to form the protection layer.

12. A beverage use can comprising:
a cylindrical part with one end portion and the other end portion; and
a bottom part positioned at the one end portion of the cylindrical part, wherein
the bottom part has an outer circumferential surface with an outer diameter gradually increasing with a move toward the other end portion of the cylindrical part, and
the outer circumferential surface of the bottom part is provided with a protection layer formed by adhesion of ink and curing of the ink.

13. The beverage use can according to claim 12, wherein a design pattern is formed in the protection layer.

14. The beverage use can according to claim 12, wherein a continuous design pattern is formed from an outer circumferential surface of the cylindrical part to the outer circumferential surface of the bottom part.

15. The beverage use can according to claim 12, wherein a character string along a circumferential direction of the beverage use can is formed in the protection layer.

16. A beverage use can comprising:
a cylindrical part with one end portion and the other end portion; and
a bottom part positioned at the one end portion of the cylindrical part, wherein
the bottom part has an outer circumferential surface with an outer diameter gradually increasing with a move toward the other end portion of the cylindrical part, and
the outer circumferential surface of the bottom part is provided with a protection layer containing a coloring material.

17. A printing device performing printing onto a beverage use can provided with a cylindrical part with one end portion and the other end portion, and a bottom part positioned at the one end portion of the cylindrical part, the bottom part having an outer circumferential surface with an outer diameter gradually increasing with a move toward the other end portion of the cylindrical part, the printing device comprising:
a protection layer forming unit applying ink to the outer circumferential surface of the bottom part to form a protection layer on the outer circumferential surface.
